(19) United States
(12) Patent Application Publication
(10) Pub. No.: US 2026/0072288 A1
(43) Pub. Date: Mar. 12, 2026

(54) LASER SYSTEM AND METHOD FOR MANUFACTURING ELECTRONIC DEVICE

(71) Applicant: Gigaphoton Inc., Tochigi (JP)

(72) Inventor: Masaki ARAKAWA, Oyama-shi (JP)

(73) Assignee: Gigaphoton Inc., Tochigi (JP)

(21) Appl. No.: 19/294,270

(22) Filed: Aug. 7, 2025

(30) Foreign Application Priority Data
Sep. 12, 2024 (JP) 2024-158283

(51) Int. Cl. G02B 27/09; H01S 3/00

(52) U.S. Cl. CPC G02B 27/0927; G02B 27/0961; H01S 3/005

(57) ABSTRACT

A laser system includes a laser oscillator, a lens array including a first lens on which a first part of a laser beam output from the laser oscillator is incident and a second lens on which a second part different from the first part of the laser beam and having a smaller spatial coherence length than the first part is incident, the second lens having a smaller pitch than the first lens, and a condenser lens configured to superimpose the first and second parts that have passed through the lens array on a common irradiation surface.

### CROSS-REFERENCE TO RELATED APPLICATIONS

The present application claims the benefit of Japanese Patent Application No. 2024-158283, filed on Sep. 12, 2024, the entire contents of which are hereby incorporated by reference.

### BACKGROUND

### 1. Technical Field

The present disclosure relates to a laser system and a method for manufacturing an electronic device.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 pm to 400 pm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: U.S. Patent Application Publication No. 2006/109443

Patent Document 2: Japanese Unexamined Patent Application Publication No. 2004-093837

### SUMMARY

A laser system according to one aspect of the present disclosure includes a laser oscillator, a lens array, and a condenser lens. The lens array includes a first lens on which a first part of a laser beam output from the laser oscillator is incident, and a second lens on which a second part different from the first part of the laser beam and having a smaller spatial coherence length than the first part is incident, the second lens having a smaller pitch than the first lens. The condenser lens is configured to superimpose the first and second parts that have passed through the lens array on a common irradiation surface.

A method for manufacturing an electronic device according to one aspect of the present disclosure includes generating a laser beam with a laser system, outputting the laser beam to an exposure apparatus, and exposing a photosensitive substrate to the laser beam within the exposure apparatus to manufacture the electronic device. The laser system includes a laser oscillator, a lens array including a first lens on which a first part of the laser beam output from the laser oscillator is incident and a second lens on which a second part different from the first part of the laser beam and having a smaller spatial coherence length than the first part is incident, the second lens having a smaller pitch than the first lens, and a condenser lens configured to superimpose the first and second parts that have passed through the lens array on a common irradiation surface.

### BRIEF DESCRIPTION OF THE DRAWINGS

Some embodiments of the present disclosure will be described below, by way of example only, with reference to the accompanying drawings.

FIG. 1 illustrates a configuration of a laser system in a comparative example.

FIG. 2 illustrates an example of a light amount distribution on a beam cross section of a laser beam entering a homogenizer.

FIG. 3 illustrates a configuration of a homogenizer in the comparative example.

FIG. 4 illustrates a configuration of another homogenizer in the comparative example.

FIG. 5 illustrates a spatial coherence length and a pitch of a lens in each part of a beam cross section of a laser beam.

FIG. 6 illustrates an example of a method for measuring a spatial coherence length in each part of the laser beam.

FIG. 7 illustrates an example of a measurement result of contrast for each pinhole interval.

FIG. 8 illustrates a configuration of a homogenizer in a first embodiment.

FIG. 9 is a diagram for describing a definition of a pitch.

FIG. 10 illustrates a first example of a pitch of a lens in the first embodiment.

FIG. 11 illustrates a second example of the pitch of the lens in the first embodiment.

FIG. 12 illustrates a third example of the pitch of the lens in the first embodiment.

FIG. 13 illustrates a configuration of a homogenizer in a modification of the first embodiment.

FIG. 14 illustrates an example of the pitch of the lens in the modification of the first embodiment.

FIG. 15 illustrates a two-dimensional light amount distribution on an irradiation surface in the comparative example.

FIG. 16 illustrates a light amount distribution obtained by integrating the light amount distribution illustrated in FIG. 15 in an X direction for each of Y coordinates.

FIG. 17 illustrates a two-dimensional light amount distribution on an irradiation surface in the first embodiment.

FIG. 18 illustrates a light amount distribution obtained by integrating the light amount distribution illustrated in FIG. 17 in the X direction for each of Y coordinates.

FIG. 19 illustrates a configuration of a homogenizer in a second embodiment.

FIG. 20 illustrates a configuration of a homogenizer in a modification of the second embodiment.

FIG. 21 illustrates a configuration of a homogenizer in a third embodiment.

FIG. 22 illustrates a configuration of a laser system in a fourth embodiment.

FIG. 23 illustrates a detailed configuration of the laser system.

FIG. 24 illustrates a configuration of an exposure system.

### DESCRIPTION OF EMBODIMENTS

### <Contents>

1. Comparative Example
   1.1 Laser System 100a
   1.2 Homogenizer 1a
2. Problem of Comparative Example
3. Method for Measuring Spatial Coherence Length Xc
4. Lens Array 10c with Different Pitches P Depending on Spatial Coherence Length Xc
   4.1 Overview
   4.2 Definition of Pitch P
   4.3 Pitches P of Lenses 11c to 17c
      4.3.1 First Example
      4.3.2 Second Example
      4.3.3 Third Example
   4.4 Focal Lengths of Lenses 11c to 17c
   4.5 Lens Array 10d Including Light Shielding Part M
   4.6 Effect
5. Lens Array 10e with Main Surfaces of Lenses 11e to 17e Shifted from Each Other
   5.1 Main Surfaces of Lenses 11e to 17e
   5.2 Lens Array 10f Including Light Shielding Part M
   5.3 Effect
6. Lens Array Including First and Second Lenticular Lenses 10g and 20g
   6.1 Configuration
   6.2 Effect
7. Homogenizer 1c with Irradiation Surface 5 Positioned inside Laser Amplifier P0
   7.1 Configuration
   7.2 Operation
      7.2.1 Operation of Laser Oscillator M0
      7.2.2 Operation of Laser Amplifier P0
      7.2.3 Operation of Optical Pulse Stretcher 99
   7.3 Effect
8. Others
   8.1 Method for Manufacturing Electronic Device
   8.2 Supplements

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference signs, and any redundant description thereof is omitted.

### 1. Comparative Example

### 1.1 Laser System 100a

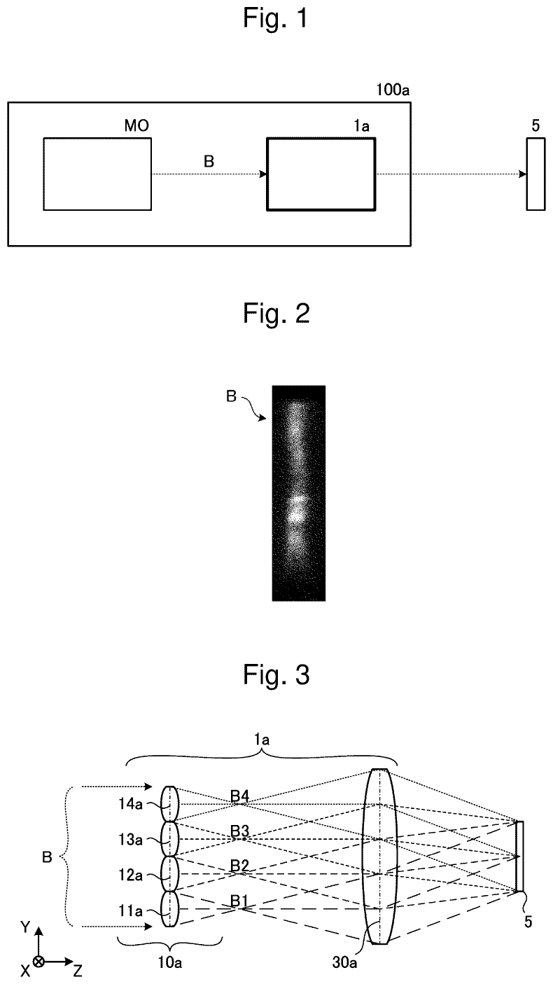

FIG. 1 illustrates a configuration of a laser system 100a in the comparative example. The comparative example of the present disclosure is an example recognized by the applicant as known only by the applicant, and is not a publicly known example admitted by the applicant.

The laser system 100a includes a laser oscillator M0 and a homogenizer 1a. The laser oscillator M0 is, for example, a discharge excitation type gas laser apparatus such as an excimer laser apparatus, and is configured to output a laser beam B. A configuration of the homogenizer 1a will be described later with reference to FIG. 3. The laser beam B passes through the homogenizer 1a to be radiated to an irradiation surface 5. The irradiation surface 5 is a processing surface of a workpiece in a device that performs processing with the laser beam B for example.

FIG. 2 illustrates an example of a light amount distribution on a beam cross section of the laser beam B entering the homogenizer 1a. A shape of the beam cross section of the laser beam B is, for example, approximately rectangular, but may have a nonuniform light amount distribution due to a distribution of a laser gas in the laser oscillator M0 or deviation of discharge that excites the laser gas. The homogenizer 1a conditions the laser beam B such that, after the laser beam B exits the homogenizer 1a, the light amount distribution on the beam cross section of the laser beam B on the irradiation surface 5 is uniformized.

### 1.2 Homogenizer 1a

FIG. 3 illustrates the configuration of the homogenizer 1a in the comparative example. The homogenizer 1a includes a lens array 10a and a condenser lens 30a. The lens array 10a includes lenses 11a to 14a disposed on the beam cross section of the laser beam B. Each of the lenses 11a to 14a is a convex lens, for example. In FIG. 3, leader lines of signs corresponding to the lenses 11a to 14a and the condenser lens 30a indicate positions of respective main surfaces of those lenses.

The laser beam B includes a part B1 incident on the lens 11a, a part B2 incident on the lens 12a, a part B3 incident on the lens 13a, and a part B4 incident on the lens 14a.

Each of the parts B1 to B4 changes a spread angle by passing through the lens array 10a. In FIG. 3, each of the parts B1 to B4 exits the lens array 10a with a negative spread angle, is then condensed once, and is made incident on the condenser lens 30a as a beam with a positive spread angle. In FIG. 3, an optical path axis and an outer edge of an optical path of each of the parts B1 to B4 are indicated by broken lines.

The condenser lens 30a superimposes the parts B1 to B4 that have passed through the lens array 10a on the common irradiation surface 5. FIG. 3 illustrates a situation where the optical path axis of each of the parts B1 to B4 is superimposed on a center part of the irradiation surface 5, a light beam at an upper end in FIG. 3 of each of the parts B1 to B4 is superimposed on an upper end part of the irradiation surface 5, and a light beam at a lower end in FIG. 3 of each of the parts B1 to B4 is superimposed on a lower end part of the irradiation surface 5. Since the parts of the laser beam B are superimposed on each other in this way, the light amount distribution is uniformized.

### 2. Problem of Comparative Example

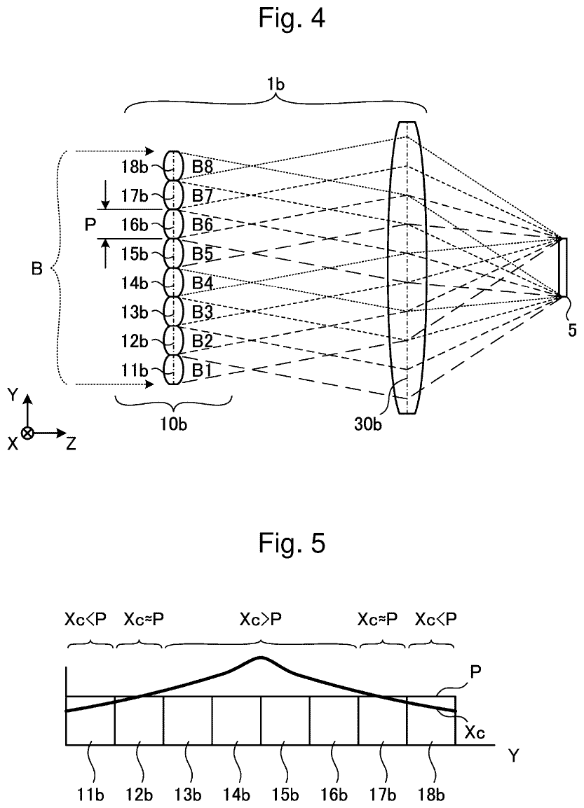

FIG. 4 illustrates a configuration of another homogenizer 1b in the comparative example. The homogenizer 1b may be used instead of the homogenizer 1a illustrated in FIG. 1. The homogenizer 1b differs from the homogenizer 1a in that the number of lenses 11b to 18b forming a lens array 10b is larger than the number of the lenses 11a to 14a forming the lens array 10a. Pitches P of the lenses 11b to 18b are smaller than those of the lenses 11a to 14a. Note that broken lines indicating optical path axes of parts B1 to B8 that have passed through the lenses 11b to 18b respectively are omitted in FIG. 4. In other respects, the lens arrays 10b, the lenses 11b, 12b, and the like, and a condenser lens 30b forming the homogenizer 1b are substantially same as corresponding components of the homogenizer 1a.

On geometrical optics, as the pitches P of the lenses 11b to 18b are smaller, the laser beam B is divided into a larger number of parts and superimposed on the irradiation surface 5 so that an effect of uniformizing the light amount distribution is improved. However, when the pitch P is smaller than a spatial coherence length Xc of the laser beam B, since diffracted light at each end of the lenses 11b to 18b is superimposed and interference fringes are generated on the irradiation surface 5, uniformization of the light amount distribution may become insufficient.

FIG. 5 illustrates the spatial coherence length Xc at each part of the beam cross section of the laser beam B and the pitch P of the lens. A horizontal axis of FIG. 5 indicates a position in a Y direction in FIG. 4, and a vertical axis of FIG. 5 indicates the spatial coherence length Xc and the pitch P. Since the pitch P corresponds to a width of the lens in the Y direction, rectangles illustrated in FIG. 5 are squares, and a length of one side of each square indicates the pitch P of each lens. As illustrated in FIG. 5, the spatial coherence length Xc may not be uniform on the beam cross section of the laser beam B. For example, the spatial coherence length Xc may be large in a center part of the laser beam B, and the spatial coherence length Xc may be small in a peripheral part. In contrast, the pitches P of the lenses 11b to 18b in the comparative example are equal to each other.

In this case, since the pitch P is substantially equal to the spatial coherence length Xc in the lenses 12b and 17b, an effect of improving uniformity of the light amount distribution is sufficiently obtained, and generation of interference fringes is suppressed as well. However, since the pitch P is larger than the spatial coherence length Xc in the lenses 11b and 18b at the end part of the lens array 10b, even though there is room to improve the uniformity of the light amount distribution if the pitch P is further reduced, the effect is not sufficiently obtained. On the other hand, since the pitch P is smaller than the spatial coherence length Xc in the lenses 13b to 16b around a center of the lens array 10b, interference fringes may be generated.

Therefore, in the comparative example, even when the pitch P is adjusted, there are problems that the effect of improving the uniformity of the light amount distribution is not sufficiently obtained in a part of the laser beam B and the interference fringes are generated in the other part.

The embodiments described below are related to improving the uniformity of the light amount distribution and suppressing the generation of interference fringes not by making the pitches P of the lenses included in the lens array be equal to each other but by attaining the pitch P according to the spatial coherence length Xc.

### 3. Method for Measuring Spatial Coherence Length Xc

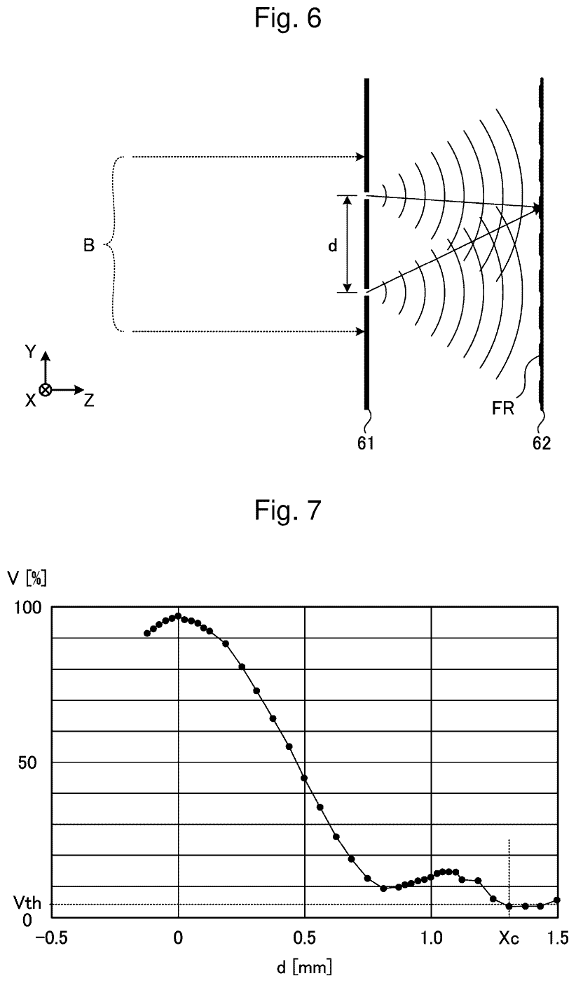

FIG. 6 illustrates an example of a method for measuring the spatial coherence length Xc in each part of the laser beam B. In this example, light diffracted by a double pinhole formed in a mask 61 is observed on a screen 62 sufficiently separated from the mask 61 and visibility of an interference fringe FR is measured as contrast V. When a pinhole interval d is gradually increased from 0 in each part of the laser beam B different in the Y direction, the contrast V of the interference fringe FR formed on the screen 62 is reduced.

FIG. 7 illustrates an example of a measurement result of the contrast V for each pinhole interval d. The pinhole interval d when the contrast V becomes less than or equal to a threshold Vth can be measured as the spatial coherence length Xc of the part. The threshold Vth is set at such a value that it can be determined that coherence is sufficiently low and is larger than measurement noise of the contrast V if the contrast V is less than or equal to the threshold Vth, and is, for example, a value more than or equal to 3% and less than or equal to 5%. For example, the spatial coherence length Xc obtained from FIG. 7 is approximately 1.3 mm.

In addition to measuring the spatial coherence length Xc in each part of the laser beams B different in the Y direction, the spatial coherence length Xc may be measured in each part different in the X direction.

### 4. Lens Array 10c with Different Pitches P Depending on Spatial Coherence Length Xc

### 4.1 Overview

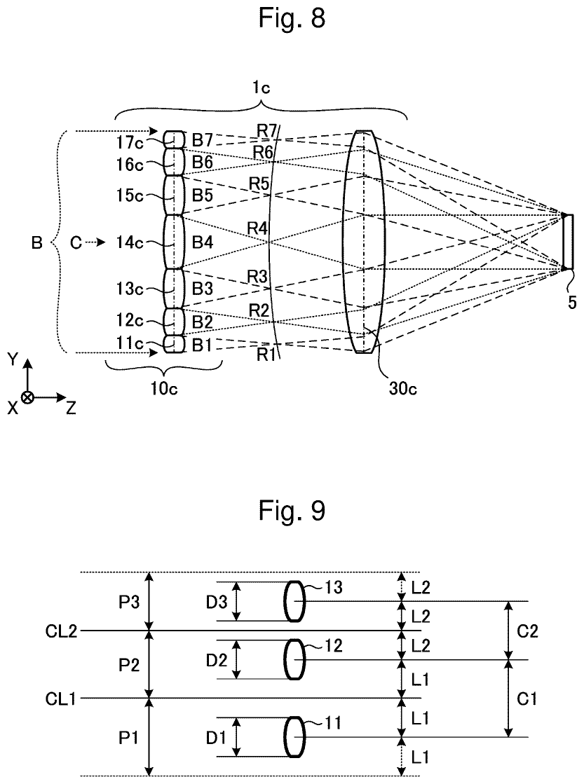

FIG. 8 illustrates a configuration of a homogenizer 1c in a first embodiment. The homogenizer 1c may be used instead of the homogenizer 1a illustrated in FIG. 1. The homogenizer 1c differs from the homogenizers 1a and 1b in that the pitches P of lenses 11c to 17c forming a lens array 10c are not unified.

### 4.2 Definition of Pitch P

FIG. 9 is a diagram for describing a definition of the pitch P. In the present disclosure, an interval of center-to-center lines between centers of adjacent lenses is defined as the pitch P. For example, it is assumed that a lens array includes lenses 11 to 13. The interval of a center-to-center line CL1 between the centers of the adjacent lenses 11 and 12 and a center-to-center line CL2 between the centers of the adjacent lenses 12 and 13 is a pitch P2 of the lens 12. That is, if a half of a distance C1 between the centers of the adjacent lenses 11 and 12 is L1 and a half of a distance C2 between the centers of the adjacent lenses 12 and 13 is L2, a total of L1 and L2 is the pitch P2 of the lens 12.

Regarding the pitches P of the lenses 11 and 13 at the end part of the lens array, twice the distance between the center of the lens and the center-to-center line between the centers of the lens and the adjacent lens is defined as the pitch P. For example, twice the distance L1 between the center of the lens 11 and the center-to-center line CL1 between the centers of the lenses 11 and 12 is a pitch P1 of the lens 11. Twice the distance L2 between the center of the lens 13 and the center-to-center line CL2 between the centers of the lenses 13 and 12 is a pitch P3 of the lens 13.

These pitches P1 to P3 do not necessarily coincide with the distance C1 between the centers of the adjacent lenses 11 and 12 and the distance C2 between the centers of the adjacent lenses 12 and 13. In addition, the pitches P1 to P3 are larger than or equal to aperture sizes D1 to D3 of the lenses 11 to 13. In FIG. 8, the pitches P of the lenses 11c to 17c are approximately equal to aperture sizes of the lenses 11c to 17c.

### 4.3 Pitches P of Lenses 11c to 17c

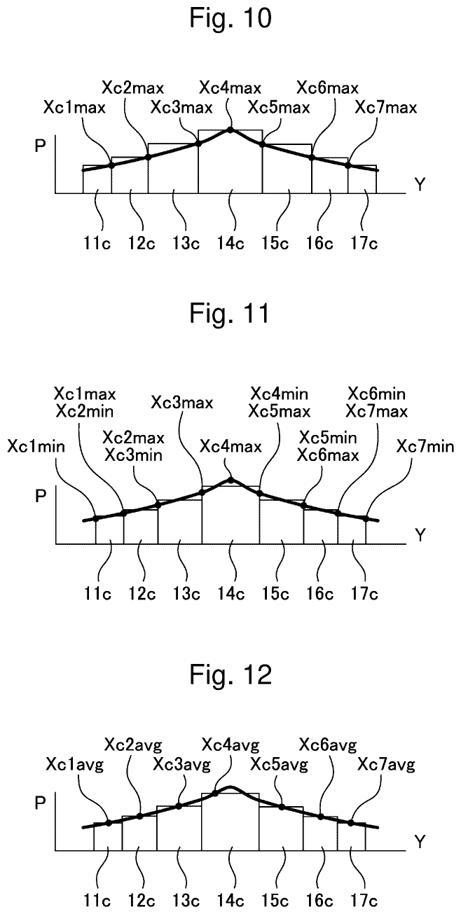

FIGS. 10 to 12 illustrate first to third examples of the pitches P of the lenses 11c to 17c in the first embodiment. FIGS. 10 to 12 also illustrate the spatial coherence lengths Xc at the parts of the beam cross section of the laser beam B similarly to FIG. 5. Each of rectangles illustrated in FIGS. 10 to 12 is a square, and the length of one side of each square indicates the pitch P of each lens.

As in the first to third examples described below, it is desirable to increase the pitch P of the lens on which a part of the laser beam B having the large spatial coherence length Xc is incident and to decrease the pitch P of the lens on which a part having the small spatial coherence length Xc of the laser beam B is incident. For example, the pitch P of the lens 15c on which the part B5 having the smaller spatial coherence length Xc than the part B4 is incident is made smaller than the pitch P of the lens 14c on which the part B4 of the laser beam B is incident. Further, the pitch P of the lens 16c on which the part B6 having the smaller spatial coherence length Xc than the part B5 is made smaller than the pitch P of the lens 15c on which the part B5 is incident.

Here, a case where the spatial coherence length Xc in the center part of the laser beam B is large and the spatial coherence length Xc in the peripheral part is small is exemplified. For example, a distance between the part B4 having the large spatial coherence length Xc and a center C of the beam cross section of the laser beam B (see FIG. 8) is shorter than a distance between the part B5 having the smaller spatial coherence length Xc than the part B4 and the center C of the beam cross section. In this case, the pitch P of the lens 15c positioned away from the center of the lens array 10c is made smaller than that of the lens 14c positioned at the center of the lens array 10c. However, the present disclosure is not limited thereto, the spatial coherence length Xc in the center part of the laser beam B may be small, and the spatial coherence length Xc in the peripheral part may be large.

### 4.3.1 First Example

In the first example illustrated in FIG. 10, the pitch P of each lens is a maximum value of the spatial coherence length Xc of the part of the laser beam B that is incident on the lens. For example, the pitch P of the lens 14c is a maximum value Xc4max of the spatial coherence length Xc of the part B4 incident on the lens 14c. The pitch P of the lens 15c is a maximum value Xc5max of the spatial coherence length Xc of the part B5 incident on the lens 15c.

The pitch P of each lens may be larger than the maximum value of the spatial coherence length Xc of the part of the laser beam B that is incident on the lens.

### 4.3.2 Second Example

In the second example illustrated in FIG. 11, the pitch P of each lens is larger than a minimum value of the spatial coherence length Xc of the part of the laser beam B that is incident on the lens. Further, the pitch P of each lens is smaller than the maximum value of the spatial coherence length Xc of the part of the laser beam B that is incident on the lens. For example, the pitch P of the lens 14c is larger than a minimum value Xc4min of the spatial coherence length Xc of the part B4 incident on the lens 14c and is smaller than the maximum value Xc4max. The pitch P of the lens 15c is larger than a minimum value Xc5min of the spatial coherence length Xc of the part B5 incident on the lens 15c and is smaller than the maximum value Xc5max. The pitch P of the lens 16c is larger than a minimum value Xc6min of the spatial coherence length Xc of the part B6 incident on the lens 16c and is smaller than a maximum value Xc6max.

### 4.3.3 Third Example

In the third example illustrated in FIG. 12, the pitch P of each lens is an average value of the spatial coherence length Xc of the part of the laser beam B that is incident on the lens. For example, the pitch P of the lens 14c is an average value Xc4avg of the spatial coherence length Xc of the part B4 incident on the lens 14c. The pitch P of the lens 15c is an average value Xc5avg of the spatial coherence length Xc of the part B5 incident on the lens 15c. The pitch P of the lens 16c is an average value Xc6avg of the spatial coherence length Xc of the part B6 incident on the lens 16c.

The pitch P of each lens may be larger than the average value of the spatial coherence length Xc of the part of the laser beam B that is incident on the lens.

### 4.4 Focal Lengths of Lenses 11c to 17c

Referring back to FIG. 8, for the lenses 11c to 17c, the smaller the pitch P, the smaller the aperture size. For example, the aperture size of the lens 15c is smaller than the aperture size of the lens 14c. Parameters and dispositions of the lenses 11c to 17c are set as follows so that differences in the size on the irradiation surface 5 of the parts B1 to B7 that have passed through the lenses 11c to 17c are reduced, preferably so that the sizes on the irradiation surface 5 of the parts B1 to B7 are equal to each other.

For the lenses 11c to 17c, the smaller the aperture size, the longer the focal length. That is, of the parts B1 to B7 that have passed through the lenses 11c to 17c, the distance between the main surfaces of the lenses 11c to 17c and light condensing positions R1 to R7 is longer for the part that has passed through the lens of the smaller aperture size. For example, a second distance between the main surface of the lens 15c and the light condensing position R5 of the part B5 that has passed through the lens 15c is longer than a first distance between the main surface of the lens 14c and the light condensing position R4 of the part B4 that has passed through the lens 14c.

It is desirable that a difference between a third distance between the main surface of the lens 14c and a main surface of a condenser lens 30c and a fourth distance between the main surface of the lens 15c and the main surface of the condenser lens 30c be smaller than a difference between the first distance between the main surface of the lens 14c and the light condensing position R4 and the second distance between the main surface of the lens 15c and the light condensing position R5. In FIG. 8, the main surfaces of the lenses 11c to 17c and the main surface of the condenser lens 30c are at an equal distance.

In addition, of the parts B1 to B7, the distance between the light condensing positions R1 to R7 and the main surface of the condenser lens 30c is shorter for the part that has passed through the lens of the smaller aperture size. For example, a sixth distance between the light condensing position R5 of the part B5 that has passed through the lens 15c and the main surface of the condenser lens 30c is shorter than a fifth distance between the light condensing position R4 of the part B4 that has passed through the lens 14c and the main surface of the condenser lens 30c.

The lens 14c corresponds to a first lens in the present disclosure, the lens 15c corresponds to a second lens in the present disclosure, and the lens 16c corresponds to a third lens in the present disclosure. The part B4 corresponds to a first part in the present disclosure, the part B5 corresponds to a second part in the present disclosure, and the part B6 corresponds to a third part in the present disclosure. The light condensing position R4 corresponds to a first light condensing position in the present disclosure, and the light condensing position R5 corresponds to a second light condensing position in the present disclosure.

### 4.5 Lens Array 10d Including Light Shielding Part M

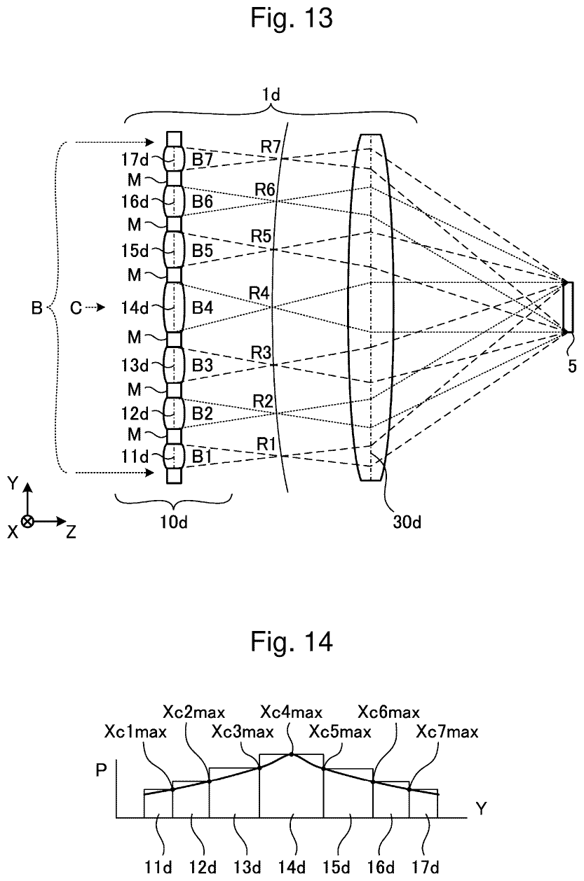

FIG. 13 illustrates a configuration of a homogenizer 1d in a modification of the first embodiment. The homogenizer 1d may be used instead of the homogenizer 1a illustrated in FIG. 1. The homogenizer 1d differs from the homogenizer 1c in that a light shielding part M is disposed between adjacent lenses of lenses 11d to 17d forming a lens array 10d. In this case, the aperture sizes of the lenses 11d to 17d are smaller than the respective pitches P. For example, if a planar shape of each of the lenses 11d to 17d is circular, since it is impossible to fill an entire surface of the lens array 10d with the lenses, the light shielding part M may be disposed between the lenses.

FIG. 13 illustrates an example in which the aperture sizes of the lenses 11d to 17d are reduced as the pitch P is smaller, similarly to the homogenizer 1c, however, the present disclosure is not limited thereto. The aperture sizes of the lenses 11d to 17d may be made equal to each other by making the light shielding part M near the center of the lens array 10d larger than the light shielding part M near the periphery of the lens array 10d.

FIG. 14 illustrates an example of the pitches P of the lenses 11d to 17d in the modification of the first embodiment. Besides the signs of the lenses 11d to 17d, FIG. 14 is similar to FIG. 10. Alternatively, the pitches P of the lenses 11d to 17d may be determined in the same manner as in FIG. 11 or FIG. 12 in the modification of the first embodiment.

In other respects, the homogenizer 1d is similar to the homogenizer 1c.

### 4.6 Effect

(1) According to the first embodiment, the laser system 100a includes the laser oscillator M0, the lens array 10c, and the condenser lens 30c. The lens array 10c includes the lens 14c on which the part B4 of the laser beam B output from the laser oscillator M0 is incident, and the lens 15c on which the part B5 different from the part B4 of the laser beam B and having the smaller spatial coherence length Xc than the part B4 is incident, the lens 15c having the smaller pitch P than the lens 14c. The condenser lens 30c superimposes the parts B4 and B5 that have passed through the lens array 10c on the common irradiation surface 5.

Accordingly, the pitch P of the lens 15c on which the part B5 having the small spatial coherence length Xc is incident is made smaller than that of the lens 14c on which the part B4 having the large spatial coherence length Xc is incident. Therefore, it is possible to reduce the problems that the effect of uniformizing the light amount distribution is insufficient for the part B5 when the pitches P of the lenses 14c and 15c are set to the value optimum for the part B4 and interference fringes due to the part B4 are generated when the pitches P of the lenses 14c and 15c are set to the value optimum for the part B5. Thus, while improving the uniformity of the light amount distribution of the laser beam B, it is possible to suppress the generation of interference fringes.

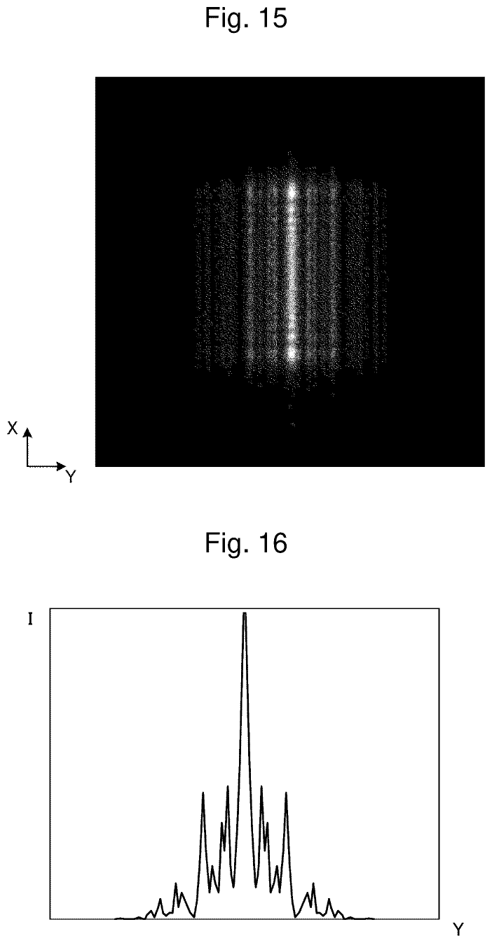

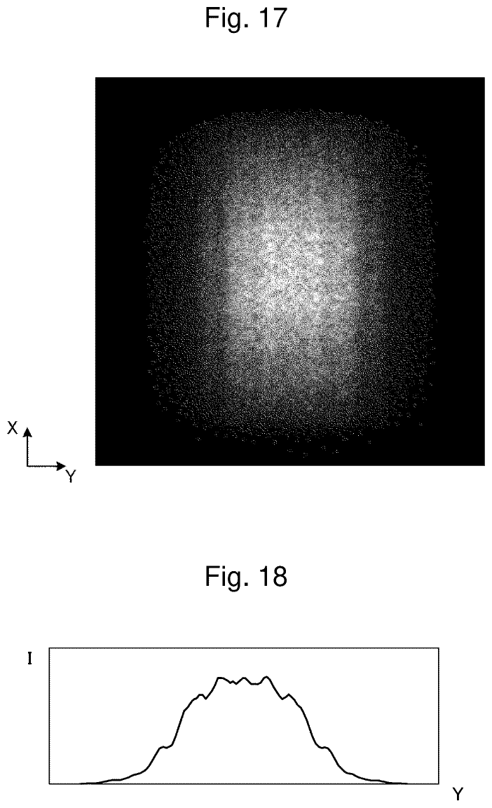

FIG. 15 illustrates a two-dimensional light amount distribution on the irradiation surface 5 in the comparative example, and FIG. 16 illustrates a light amount distribution obtained by integrating the light amount distribution illustrated in FIG. 15 in the X direction for each of Y coordinates. FIG. 17 illustrates a two-dimensional light amount distribution on the irradiation surface 5 in the first embodiment, and FIG. 18 illustrates a light amount distribution obtained by integrating the light amount distribution illustrated in FIG. 17 in the X direction for each of the Y coordinates. While the pitch P is set too small and variation in a light amount due to interference is large in FIGS. 15 and 16, in FIGS. 17 and 18, the interference is suppressed and the light amount distribution is uniformized. Note that FIGS. 17 and 18 do not illustrate a limit of ability of uniformizing the light amount distribution by the present disclosure.

(2) According to the first embodiment, the lens array 10c includes the lens 16c on which the part B6 different from both of the parts B4 and B5 of the laser beam B and having the smaller spatial coherence length Xc than the part B5 is incident, the lens 16c having the smaller pitch P than the lens 15c. The condenser lens 30c superimposes the parts B4 to B6 that have passed through the lens array 10c on the common irradiation surface 5.

Accordingly, by causing not only the lenses 14c and 15c but also the lens 16c to have the pitch P corresponding to the spatial coherence length Xc, the effect of improving the uniformity of the light amount distribution and the effect of suppressing the generation of interference fringes can be obtained in a wide range of the beam cross section.

(3) According to the first embodiment, the distance between the part B4 and the center C of the beam cross section of the laser beam B is shorter than the distance between the part B5 and the center C.

Accordingly, when the spatial coherence length Xc is larger in the center part than in the peripheral part of the beam cross section, it is possible to obtain the effect of improving the uniformity of the light amount distribution and the effect of suppressing the generation of interference fringes.

(4) According to the first embodiment, the pitch P of the lens 14c is larger than or equal to the maximum value Xc4max of the spatial coherence length Xc of the part B4, and the pitch P of the lens 15c is larger than or equal to the maximum value Xc5max of the spatial coherence length Xc of the part B5.

Accordingly, the pitch P is suppressed from becoming smaller than the spatial coherence length Xc of the parts B4 and B5 incident on the lenses 14c and 15c, and the generation of interference fringes can be more reliably suppressed.

(5) According to the first embodiment, the pitch P of the lens 14c is larger than the minimum value Xc4min of the spatial coherence length Xc of the part B4, and the pitch P of the lens 15c is larger than the minimum value Xc5min of the spatial coherence length Xc of the part B5.

Accordingly, the pitch P is suppressed from becoming significantly smaller than the spatial coherence length Xc of the parts B4 and B5 incident on the lenses 14c and 15c, and the generation of interference fringes can be suppressed.

(6) According to the first embodiment, the pitch P of the lens 14c is smaller than the maximum value Xc4max of the spatial coherence length Xc of the part B4, and the pitch P of the lens 15c is smaller than the maximum value Xc5max of the spatial coherence length Xc of the part B5.

Accordingly, the pitch P is suppressed from becoming significantly larger than the spatial coherence length Xc of the parts B4 and B5 incident on the lenses 14c and 15c, and the uniformity of the light amount distribution can be improved.

(7) According to the first embodiment, the pitch P of the lens 14c is larger than or equal to the average value Xc4avg of the spatial coherence length Xc of the part B4, and the pitch P of the lens 15c is larger than or equal to the average value Xc5avg of the spatial coherence length Xc of the part B5.

Accordingly, the pitch P is suppressed from becoming smaller than the spatial coherence length Xc of the parts B4 and B5 incident on the lenses 14c and 15c, and the generation of interference fringes can be suppressed.

(8) According to the first embodiment, the aperture size of the lens 15c is smaller than the aperture size of the lens 14c.

Accordingly, by making the aperture size of the lens 14c having the large pitch P larger than the aperture size of the lens 15c having the small pitch P, energy of the laser beam B can be suppressed from being attenuated in the lens array 10c.

(9) According to the first embodiment, the second distance between the main surface of the lens 15c and the light condensing position R5 of the part B5 that has passed through the lens 15c is longer than the first distance between the main surface of the lens 14c and the light condensing position R4 of the part B4 that has passed through the lens 14c.

Accordingly, by making the second distance from the main surface of the lens 15c of the small aperture size to the light condensing position R5 long, it is possible to condense the part B5 that has passed through the lens 15c at a position closer to the condenser lens 30c and to increase a spread angle of the part B5 exiting the condenser lens 30c. Therefore, a size on the irradiation surface 5 can be increased even for the part B5 that has passed through the lens 15c of the small aperture size and can be brought closer to the size on the irradiation surface 5 of the part B4 that has passed through the lens 14c of the large aperture size, and variation in the size on the irradiation surface 5 of the parts B4 and B5 can be reduced.

(10) According to the first embodiment, the difference between the third distance between the main surface of the lens 14c and the main surface of the condenser lens 30c and the fourth distance between the main surface of the lens 15c and the main surface of the condenser lens 30c is smaller than the difference between the first and second distances.

Accordingly, by reducing the difference between the third and fourth distances, the main surfaces of the lenses 14c and 15c can be positioned close to each other. Thus, manufacture of the lens array 10c can be facilitated.

(11) According to the first embodiment, the sixth distance between the light condensing position R5 and the main surface of the condenser lens 30c is shorter than the fifth distance between the light condensing position R4 and the main surface of the condenser lens 30c.

Accordingly, the size on the irradiation surface 5 can be increased even for the part B5 that has passed through the lens 15c of the small aperture size, and the variation in size on the irradiation surface 5 of the parts B4 and B5 can be reduced.

In other respects, the first embodiment is similar to the comparative example.

### 5. Lens Array 10e with Main Surfaces of Lenses 11e to 17e Shifted from Each Other

### 5.1 Main Surfaces of Lenses 11e to 17e

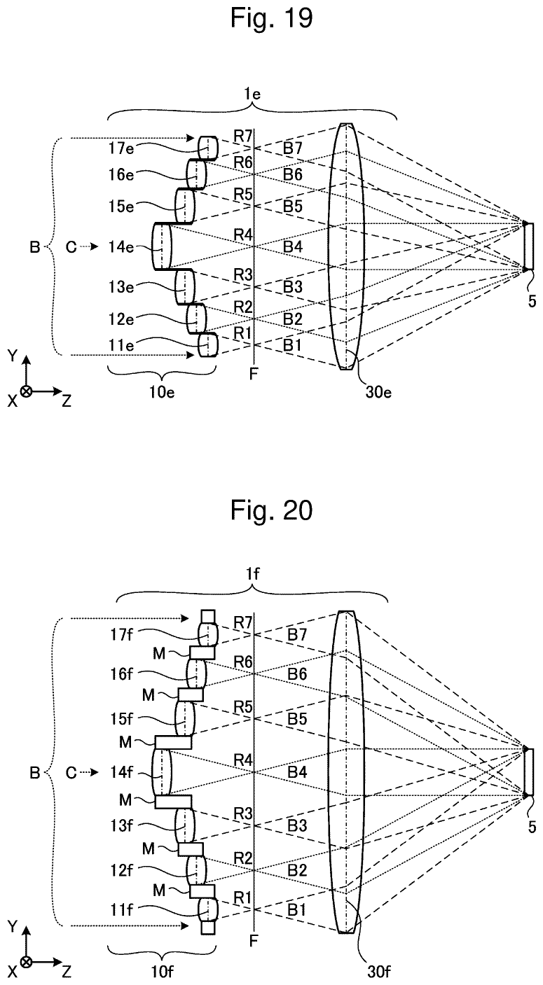

FIG. 19 illustrates a configuration of a homogenizer 1e in a second embodiment. The homogenizer 1e may be used instead of the homogenizer 1a illustrated in FIG. 1. The homogenizer 1e differs from the homogenizer 1c in that the positions of the main surfaces of lenses 11e to 17e forming a lens array 10e are different from each other. It is similar to the homogenizer 1c in that the pitches P of the lenses 11e to 17e are made smaller as the spatial coherence length Xc is smaller.

For the lenses 11e to 17e, the smaller the pitch P, the smaller the aperture size. Parameters and dispositions of the lenses 11e to 17e are set as follows so that the differences in the size and the differences in the spread angle among the parts B1 to B7 incident on the irradiation surface 5 are reduced, preferably so that the sizes of the parts B1 to B7 incident on the irradiation surface 5 are equal to each other and the spread angles are equal to each other.

For the lenses 11e to 17e, the smaller the aperture size, the shorter the focal length. That is, of the parts B1 to B7 that have passed through the lenses 11e to 17e, the distance between the main surfaces of the lenses 11e to 17e and the light condensing positions R1 to R7 is shorter for the part that has passed through the lens of the smaller aperture size. For example, a second distance between the main surface of the lens 15e and the light condensing position R5 of the part B5 that has passed through the lens 15e is shorter than a first distance between the main surface of the lens 14e and the light condensing position R4 of the part B4 that has passed through the lens 14e.

Further, the smaller the aperture size of the lenses 11e to 17e, the shorter the distance between the main surfaces of the lenses 11e to 17e and the main surface of the condenser lens 30e. For example, the fourth distance between the main surface of the lens 15e and the main surface of a condenser lens 30e is shorter than the third distance between the main surface of the lens 14e and the main surface of the condenser lens 30e.

It is desirable that a difference between the fifth distance between the light condensing position R4 and the main surface of the condenser lens 30e and the sixth distance between the light condensing position R5 and the main surface of the condenser lens 30e be smaller than a difference between the first distance between the main surface of the lens 14e and the light condensing position R4 and the second distance between the main surface of the lens 15e and the light condensing position R5. In FIG. 19, the light condensing positions R1 to R7 and the main surface of the condenser lens 30e are at an equal distance.

It is desirable that the light condensing positions R1 to R7 corresponding to rear focal points of the lenses 11e to 17e be positioned on a front focal plane F of the condenser lens 30e.

It is desirable that a difference in numerical apertures of the lenses 11e to 17e be small. In FIG. 19, the numerical apertures of the lenses 11e to 17e are equal to each other.

The lens 14e corresponds to the first lens in the present disclosure, and the lens 15e corresponds to the second lens in the present disclosure.

### 5.2 Lens Array 10f Including Light Shielding Part M

FIG. 20 illustrates a configuration of a homogenizer 1f in a modification of the second embodiment. The homogenizer 1f may be used instead of the homogenizer 1a illustrated in FIG. 1. The homogenizer 1f differs from the homogenizer 1e in that the light shielding part M is disposed between adjacent lenses of lenses 11f to 17f forming a lens array 10f.

FIG. 20 illustrates an example in which the aperture sizes of the lenses 11f to 17f are reduced as the spatial coherence length Xc is smaller, similarly to the homogenizer 1e, however, the present disclosure is not limited thereto. The aperture sizes of the lenses 11f to 17f may be made equal to each other.

In other respects, the homogenizer 1f is similar to the homogenizer 1e.

### 5.3 Effect

(12) According to the second embodiment, the aperture size of the lens 15e is smaller than the aperture size of the lens 14e, and the fourth distance between the main surface of the lens 15e and the main surface of the condenser lens 30e is shorter than the third distance between the main surface of the lens 14e and the main surface of the condenser lens 30e.

Accordingly, by making the fourth distance between the main surface of the lens 15e of the small aperture size and the main surface of the condenser lens 30e shorter than the third distance between the main surface of the lens 14e and the main surface of the condenser lens 30e, the difference in the size and the difference in the spread angle between the parts B4 and B5 incident on the irradiation surface 5 can be reduced. Therefore, even when the irradiation surface 5 is shifted in parallel with a traveling direction of the laser beam B, decline of the uniformity of the laser beam B is suppressed.

(13) According to the second embodiment, the second distance between the main surface of the lens 15e and the light condensing position R5 of the part B5 that has passed through the lens 15e is shorter than the first distance between the main surface of the lens 14e and the light condensing position R4 of the part B4 that has passed through the lens 14e. In addition, the difference between the fifth distance between the light condensing position R4 and the main surface of the condenser lens 30e and the sixth distance between the light condensing position R5 and the main surface of the condenser lens 30e is smaller than the difference between the first and second distances.

Accordingly, by reducing the difference between the distances between the light condensing positions R4 and R5 and the main surface of the condenser lens 30e, it is possible to reduce the difference in the spread angle between the parts B4 and B5 that have passed through the condenser lens 30e. Further, by making the second distance between the main surface of the lens 15e of the small aperture size and the light condensing position R5 shorter than the first distance between the main surface of the lens 14e and the light condensing position R4, it is possible to reduce a difference in a beam diameter between the parts B4 and B5 that have passed through the condenser lens 30e. Therefore, even when the irradiation surface 5 is shifted in parallel with the traveling direction of the laser beam B, the decline of the uniformity of the laser beam B is suppressed.

(14) According to the second embodiment, the lenses 14e and 15e and the condenser lens 30e are disposed such that the light condensing positions R4 and R5 corresponding to the rear focal points of the lenses 14e and 15e respectively are positioned on the front focal plane F of the condenser lens 30e.

Accordingly, by positioning the rear focal points of the lenses 14e and 15e on the front focal plane F of the condenser lens 30e, the parts B4 and B5 that have passed through the condenser lens 30e are turned to substantially parallel light respectively, and the high-quality laser beam B can be output to the irradiation surface 5.

(15) According to the second embodiment, the numerical apertures of the lenses 14e and 15e are equal to each other.

Accordingly, by equalizing the numerical apertures, widths of optical paths of the parts B4 and B5 that have passed through the condenser lens 30e are matched, and the high-quality laser beam B can be output to the irradiation surface 5.

In other respects, the second embodiment is similar to the first embodiment.

### 6. Lens Array Including First and Second Lenticular Lenses 10g and 20g

### 6.1 Configuration

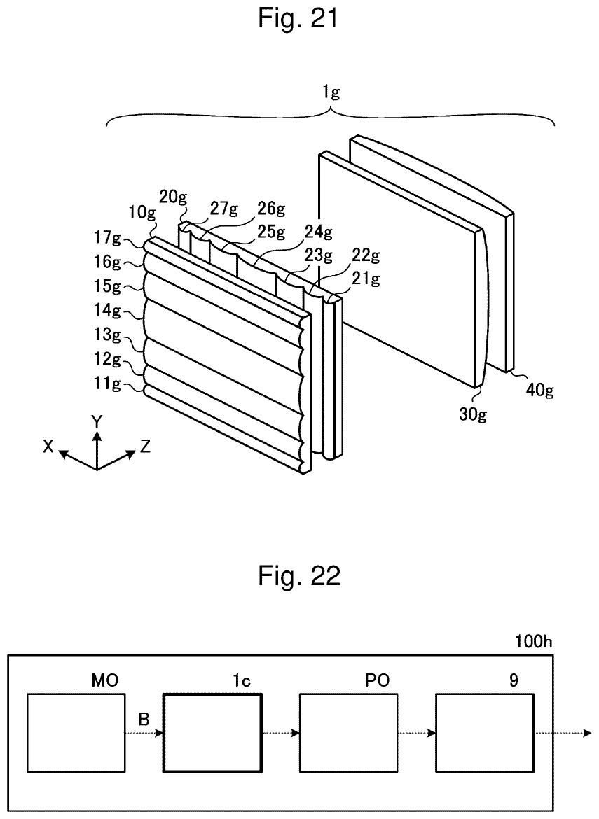

FIG. 21 illustrates a configuration of a homogenizer 1g in a third embodiment. The homogenizer 1g may be used instead of the homogenizer 1a illustrated in FIG. 1. The homogenizer 1g differs from the homogenizers 1c to 1f in that it includes first and second lenticular lenses 10g and 20g and condenser lenses 30g and 40g. The first and second lenticular lenses 10g and 20g form a lens array of the present disclosure. The laser beam B that has passed through the first lenticular lens 10g is incident on the second lenticular lens 20g. The condenser lenses 30g and 40g superimpose the parts of the laser beam B that has passed through the first and second lenticular lenses 10g and 20g on a common illumination surface.

Lenses 11g to 17g forming the first lenticular lens 10g each have a focal axis parallel to each other, and the focal axes are parallel, for example, to the X direction. Lenses 21g to 27g forming the second lenticular lens 20g each have a focal axis parallel to each other, and the focal axes are non-parallel to the focal axes of the lenses 11g to 17g and are parallel, for example, to the Y direction.

The condenser lens 30g includes a cylindrical lens having a focal axis parallel to the focal axes of the lenses 11g to 17g . The condenser lens 40g includes a cylindrical lens having a focal axis parallel to the focal axes of the lenses 21g to 27g.

It is similar to the homogenizers 1c to 1f in that the pitches P of the lenses 11g to 17g and the lenses 21g to 27g are made smaller as the spatial coherence length Xc is smaller. For example, the spatial coherence length Xc of the part incident on the lens 15g is smaller than that of the part of the laser beam B that is incident on the lens 14g, and the pitch P of the lens 15g is smaller than that of the lens 14g. The spatial coherence length Xc of the part incident on the lens 25g is smaller than that of the part of the laser beam B that is incident on the lens 24g, and the pitch P of the lens 25g is smaller than that of the lens 24g.

The lens 14g corresponds to the first lens in the present disclosure, and the lens 15g corresponds to the second lens in the present disclosure. The focal axis of the lens 14g corresponds to a first focal axis in the present disclosure, and the focal axis of the lens 15g corresponds to a second focal axis in the present disclosure. The focal axis of the condenser lens 30g corresponds to a third focal axis in the present disclosure.

The lens 24g corresponds to a fourth lens in the present disclosure, and the lens 25g corresponds to a fifth lens in the present disclosure. The part of the laser beam B incident on the lens 24g corresponds to a fourth part in the present disclosure, and the part incident on the lens 25g corresponds to a fifth part in the present disclosure. The focal axis of the lens 24g corresponds to a fourth focal axis in the present disclosure, and the focal axis of the lens 25g corresponds to a fifth focal axis in the present disclosure.

### 6.2 Effect

(16) According to the third embodiment, the lenses 14g and 15g form the first lenticular lens 10g included in the lens array, and have the focal axes parallel to each other, respectively.

Accordingly, by using the first lenticular lens 10g, it is possible to reduce a gap between the lenses 14g and 15g.

(17) According to the third embodiment, the condenser lens 30g includes the cylindrical lens having the focal axis parallel to the focal axes of the lenses 14g and 15g.

Accordingly, by using the condenser lens 30g having the focal axis corresponding to the focal axes of the lenses 14g and 15g, the parts of the laser beam B that have passed through the lenses 14g and 15g respectively can be superimposed on the common irradiation surface 5.

(18) According to the third embodiment, the lens array includes the second lenticular lens 20g on which the laser beam B that has passed through the first lenticular lens 10g is incident. The second lenticular lens 20g includes the lens 24g on which a part of the laser beam B is incident, and the lens 25g on which the part different from the part of the laser beam B that is incident on the lens 24g and having the smaller spatial coherence length Xc than the part incident on the lens 24g is incident, the lens 25g having the pitch P smaller than that of the lens 24g. The lenses 24g and 25g have the focal axes parallel to each other and non-parallel to the focal axes of the lenses 14g and 15g, respectively, and the condenser lenses 30g and 40g superimpose the parts of the laser beam B that have been incident on the lenses 24g and 25g and have passed through the lens array on the common irradiation surface 5.

Accordingly, by using the second lenticular lens 20g non-parallel to the focal axis of the first lenticular lens 10g, it is possible to obtain the effect of improving the uniformity of the light amount distribution in a plurality of directions and the effect of suppressing the generation of interference fringes.

In other respects, the third embodiment is the same as the first and second embodiments.

### 7. Homogenizer 1c with Irradiation Surface 5 Positioned Inside Laser Amplifier P0

### 7.1 Configuration

FIG. 22 illustrates a configuration of a laser system 100h in a fourth embodiment. The laser system 100h includes the laser oscillator M0, the homogenizer 1c, a laser amplifier P0, and an optical element 9. Any one of the homogenizers 1d to 1g may be used instead of the homogenizer 1c. The laser beam B that has passed through the homogenizer 1c enters the laser amplifier P0 to be amplified, passes through the optical element 9, and is output from the laser system 100h.

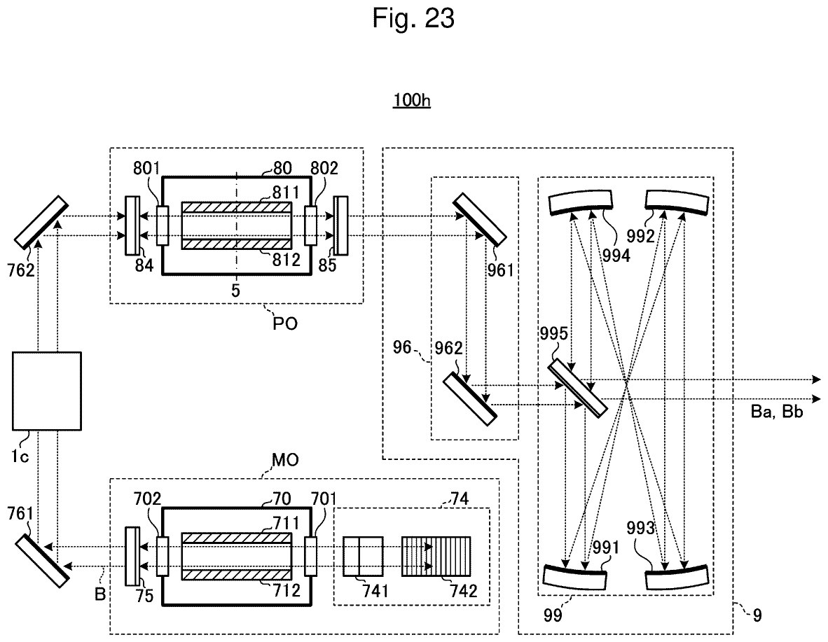

FIG. 23 illustrates a detailed configuration of the laser system 100h. The laser oscillator M0 includes a laser chamber 70, a line narrowing module 74, and an output coupling mirror 75.

The laser chamber 70 is disposed in an optical path of a laser resonator formed of the line narrowing module 74 and the output coupling mirror 75. The laser chamber 70 is provided with two windows 701 and 702. The laser chamber 70 houses discharge electrodes 711 and 712. The discharge electrodes 711 and 712 are connected to an unillustrated pulse power supply. The laser chamber 70 houses laser gas as a laser medium. The laser gas includes, for example, argon gas, fluorine gas, and neon gas. Alternatively, the laser gas includes, for example, krypton gas, fluorine gas, and neon gas.

The line narrowing module 74 includes wavelength selection elements such as a prism 741 and a grating 742. The output coupling mirror 75 is formed of a partial reflective mirror.

In an optical path of the laser beam B output from the output coupling mirror 75, a high reflective mirror 761, the homogenizer 1c, and a high reflective mirror 762 are disposed in this order.

The laser amplifier P0 includes a laser chamber 80, a rear mirror 84, and an output coupling mirror 85. The laser chamber 80, the output coupling mirror 85, and windows 801 and 802 and the discharge electrodes 811 and 812 accompanying the laser chamber 80 are similar to the corresponding components in the laser oscillator M0.

The rear mirror 84 is disposed in an optical path of the laser beam B reflected by the high reflective mirror 762. The rear mirror 84 is formed of a partial reflective mirror. The rear mirror 84 and the output coupling mirror 85 form a laser resonator.

The optical element 9 includes, for example, a beam steering unit 96 and an optical pulse stretcher 99. The beam steering unit 96 includes high reflective mirrors 961 and 962.

The optical pulse stretcher 99 is disposed in an optical path of the laser beam B that has passed through the beam steering unit 96. The optical pulse stretcher 99 includes a beam splitter 995 and first to fourth concave mirrors 991 to 994.

### 7.2 Operation

### 7.2.1 Operation of Laser Oscillator M0

In the laser oscillator M0, the unillustrated pulse power supply generates a pulsed high voltage, and applies the high voltage between the discharge electrodes 711 and 712. When the high voltage is applied between the discharge electrodes 711 and 712, discharge occurs between the discharge electrodes 711 and 712. By energy of the discharge, the laser gas in the laser chamber 70 is excited and shifts to a high energy level. When the excited laser gas then shifts to a low energy level, light having a wavelength corresponding to the energy level difference is discharged.

The light generated in the laser chamber 70 is output to an outside of the laser chamber 70 through the windows 701 and 702. The light exiting the window 701 is stretched in a beam width by the prism 741 and enters the grating 742. The light that has entered the grating 742 from the prism 741 is reflected by a plurality of grooves of the grating 742, and is also diffracted in a direction corresponding to the wavelength of the light. The grating 742 is disposed in Littrow arrangement so that an incident angle of the light entering the grating 742 from the prism 741 and a diffracting angle of the diffracted light having a desired wavelength coincide. Thus, the light around the desired wavelength is returned to the laser chamber 70 through the prism 741.

The output coupling mirror 75 transmits and outputs a part of the light exiting the window 702, and reflects the other part back into the laser chamber 70.

In this way, the light output from the laser chamber 70 reciprocates between the line narrowing module 74 and the output coupling mirror 75. The light is amplified every time it passes through a discharge space between the discharge electrodes 711 and 712. Further, the light is line-narrowed every time it is turned back in the line narrowing module 74. The light laser-oscillated and line-narrowed in this way is output as the laser beam B from the output coupling mirror 75.

### 7.2.2 Operation of Laser Amplifier P0

The laser beam B output from the output coupling mirror 75 enters the homogenizer 1c through the high reflective mirror 761. The irradiation surface 5 on which the laser beam B exiting the homogenizer 1c is incident is a virtual surface positioned inside the laser amplifier P0. The irradiation surface 5 is preferably positioned between the discharge electrodes 811 and 812. The laser beam B exiting the homogenizer 1c enters the laser chamber 80 through the high reflective mirror 762 and the rear mirror 84.

In synchronization with entry of the laser beam B to the laser chamber 80, in the laser amplifier P0, an unillustrated pulse power supply generates a pulsed high voltage, and the high voltage is applied between the discharge electrodes 811 and 812.

When the high voltage is applied between the discharge electrodes 811 and 812, discharge occurs between the discharge electrodes 811 and 812. By the energy of the discharge, the laser beam B that has entered the laser chamber 80 is amplified.

The light amplified in the laser chamber 80 reciprocates between the rear mirror 84 and the output coupling mirror 85. The light is amplified every time it passes through a discharge space between the discharge electrodes 811 and 812. The laser beam B amplified in this way is output from the output coupling mirror 85.

### 7.2.3 Operation of Optical Pulse Stretcher 99

The laser beam B output from the output coupling mirror 85 enters the beam splitter 995 of the optical pulse stretcher 99 in a right direction in FIG. 23 through the beam steering unit 96. The beam splitter 995 transmits a part of the laser beam B that has entered in the right direction in FIG. 23, allowing it to exit as a beam Ba, and reflects the other part in a downward direction in FIG. 23. The reflected laser beam B is sequentially reflected by the first to fourth concave mirrors 991 to 994, and enters the beam splitter 995 in the downward direction in FIG. 23.

The beam cross section in the beam splitter 995 of the laser beam B that has entered from the beam steering unit 96 is imaged in the beam splitter 995 in a 1:1 size by the first to fourth concave mirrors 991 to 994. The beam splitter 995 reflects a part of the laser beam B that has entered in the downward direction in FIG. 23 from the fourth concave mirror 994 in the right direction in FIG. 23, allowing it to exit as a beam Bb.

Between the beams Ba and Bb, there is a time difference according to an optical path length of a delay optical path formed of the first to fourth concave mirrors 991 to 994. By spatially overlapping the beam Ba and the beam Bb, the laser beam B with a stretched pulse width can be output.

### 7.3 Effect

(19) According to the fourth embodiment, the laser system 100h includes the laser amplifier P0 configured to receive the laser beam B that has passed through the condenser lens 30c, and the irradiation surface 5 is a virtual surface positioned inside the laser amplifier P0.

Accordingly, by making the laser beam B for which the uniformity of the light amount distribution is improved and the generation of interference fringes is suppressed enter the laser amplifier P0, the uniformity of the light amount distribution of the laser beam B amplified in the laser amplifier P0 can be improved. Further, the laser beam B that enters the optical element 9 in a subsequent stage is suppressed from having locally high energy, and a service life of the optical element 9 can be prolonged.

### 8. Others

### 8.1 Method for Manufacturing Electronic Device

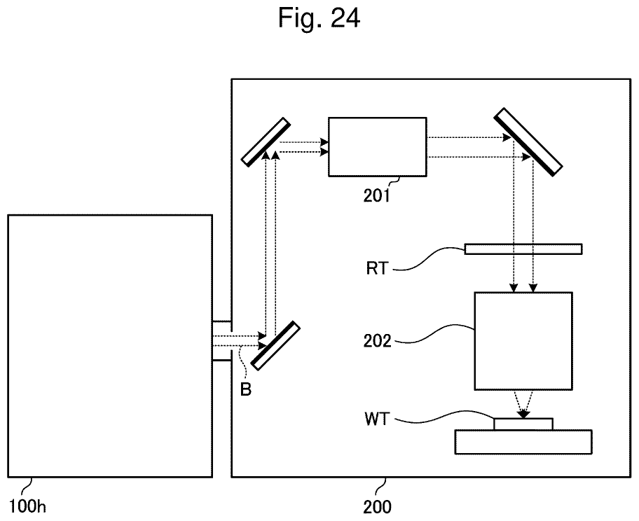

FIG. 24 illustrates a configuration of an exposure system. The exposure system includes the laser system 100h and an exposure apparatus 200. Instead of the laser system 100h, a laser system 100a may be used in which the homogenizer 1a is replaced by any one of the homogenizers 1c to 1g . The laser system 100h is configured to output the laser beam B toward the exposure apparatus 200.

The exposure apparatus 200 includes an illumination optical system 201 and a projection optical system 202. The illumination optical system 201 illuminates a reticle pattern of an unillustrated reticle disposed on a reticle stage RT with the laser beam B that has entered from the laser system 100h. The projection optical system 202 performs reduced projection of the laser beam B transmitted through the reticle, and forms an image on an unillustrated workpiece disposed on a workpiece table WT. The workpiece is a photosensitive substrate such as a semiconductor wafer on which photoresist is applied.

The exposure apparatus 200 causes the reticle stage RT and the workpiece table WT to be synchronously translated, and thus exposes the workpiece to the laser beam B reflecting the reticle pattern. After the reticle pattern is transferred onto the semiconductor wafer by such an exposure process, an electronic device can be manufactured through a plurality of processes.

### 8.2 Supplements

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser system comprising:
a laser oscillator;
a lens array including
a first lens on which a first part of a laser beam output from the laser oscillator is incident and
a second lens on which a second part different from the first part of the laser beam and having a smaller spatial coherence length than the first part is incident, the second lens having a smaller pitch than the first lens; and
a condenser lens configured to superimpose the first and second parts that have passed through the lens array on a common irradiation surface.

2. The laser system according to claim 1, wherein
the lens array further includes a third lens on which a third part different from both of the first and second parts of the laser beam and having a smaller spatial coherence length than the second part is incident, the third lens having a smaller pitch than the second lens, and
the condenser lens superimposes the first to third parts that have passed through the lens array on the common irradiation surface.

3. The laser system according to claim 1, wherein
a distance between the first part and a center of a beam cross section of the laser beam is shorter than a distance between the second part and the center.

4. The laser system according to claim 1, wherein
the pitch of the first lens is larger than or equal to a maximum value of the spatial coherence length of the first part, and
the pitch of the second lens is larger than or equal to a maximum value of the spatial coherence length of the second part.

5. The laser system according to claim 1, wherein
the pitch of the first lens is larger than a minimum value of the spatial coherence length of the first part, and
the pitch of the second lens is larger than a minimum value of the spatial coherence length of the second part.

6. The laser system according to claim 5, wherein
the pitch of the first lens is smaller than a maximum value of the spatial coherence length of the first part, and
the pitch of the second lens is smaller than a maximum value of the spatial coherence length of the second part.

7. The laser system according to claim 1, wherein
the pitch of the first lens is larger than or equal to an average value of the spatial coherence length of the first part, and
the pitch of the second lens is larger than or equal to an average value of the spatial coherence length of the second part.

8. The laser system according to claim 1, wherein
an aperture size of the second lens is smaller than an aperture size of the first lens.

9. The laser system according to claim 8, wherein
a second distance between a main surface of the second lens and a second light condensing position of the second part that has passed through the second lens is longer than a first distance between a main surface of the first lens and a first light condensing position of the first part that has passed through the first lens.

10. The laser system according to claim 9, wherein
a difference between a third distance between the main surface of the first lens and a main surface of the condenser lens and a fourth distance between the main surface of the second lens and the main surface of the condenser lens is smaller than a difference between the first and second distances.

11. The laser system according to claim 9, wherein
a sixth distance between the second light condensing position and a main surface of the condenser lens is shorter than a fifth distance between the first light condensing position and the main surface of the condenser lens.

12. The laser system according to claim 1, wherein
an aperture size of the second lens is smaller than an aperture size of the first lens, and
a fourth distance between a main surface of the second lens and a main surface of the condenser lens is shorter than a third distance between a main surface of the first lens and the main surface of the condenser lens.

13. The laser system according to claim 1, wherein
a second distance between a main surface of the second lens and a second light condensing position of the second part that has passed through the second lens is shorter than a first distance between a main surface of the first lens and a first light condensing position of the first part that has passed through the first lens, and
a difference between a fifth distance between the first light condensing position and a main surface of the condenser lens and a sixth distance between the second light condensing position and the main surface of the condenser lens is smaller than a difference between the first and second distances.

14. The laser system according to claim 1, wherein
the first and second lenses and the condenser lens are disposed such that rear focal points of the first and second lenses respectively are positioned on a front focal plane of the condenser lens.

15. The laser system according to claim 14, wherein
numerical apertures of the first and second lenses are equal to each other.

16. The laser system according to claim 1, wherein
the first and second lenses form a first lenticular lens included in the lens array, and have first and second focal axes parallel to each other, respectively.

17. The laser system according to claim 16, wherein
the condenser lens includes a cylindrical lens having a third focal axis parallel to the first and second focal axes.

18. The laser system according to claim 16, wherein
the lens array further includes a second lenticular lens on which the laser beam that has passed through the first lenticular lens is incident, the second lenticular lens including
a fourth lens on which a fourth part of the laser beam is incident, and
a fifth lens on which a fifth part different from the fourth part of the laser beam and having a smaller spatial coherence length than the fourth part is incident, the fifth lens having a smaller pitch than the fourth lens,
the fourth and fifth lenses have fourth and fifth focal axes parallel to each other and non-parallel to the first and second focal axes, respectively, and
the condenser lens superimposes the fourth and fifth parts that have passed through the lens array on the common irradiation surface.

19. The laser system according to claim 1, further comprising
a laser amplifier configured to receive the laser beam that has passed through the condenser lens, wherein
the irradiation surface is a virtual surface positioned inside the laser amplifier.

20. A method for manufacturing an electronic device comprising:
generating a laser beam with a laser system, the laser system including
a laser oscillator,
a lens array including
a first lens on which a first part of the laser beam output from the laser oscillator is incident and
a second lens on which a second part different from the first part of the laser beam and having a smaller spatial coherence length than the first part is incident, the second lens having a smaller pitch than the first lens, and
a condenser lens configured to superimpose the first and second parts that have passed through the lens array on a common irradiation surface;
outputting the laser beam to an exposure apparatus; and
exposing a photosensitive substrate to the laser beam within the exposure apparatus to manufacture the electronic device.
